(19) United States
(12) Patent Application Publication
(10) Pub. No.: US 2008/0122405 A1
(43) Pub. Date: May 29, 2008

(54) Constant voltage and constant current power source

(75) Inventor: Toshiaki Fujikura, Tokyo (JP)

Correspondence Address: MORGAN LEWIS & BOCKIUS LLP, 1111 PENNSYLVANIA AVENUE NW, WASHINGTON, DC, 20004, US

(73) Assignee: Uniden Corporation

(21) Appl. No.: 11/711,103

(22) Filed: Feb. 27, 2007

(30) Foreign Application Priority Data
Nov. 28, 2006 (JP) 2006-319437

(51) Int. Cl. H02J 7/04

(52) U.S. Cl. 320/149

(57) ABSTRACT

A filter for smoothing pulse voltage outputted by a transistor has a diode, an inductance, a resistor element and a capacitor. The resistor element is functionally homologous to the equivalent series resistance of the capacitor. A capacitor having a low equivalent series resistance can be used as the capacitor by virtue of employing as the resistor element a resistor having a resistance value such that the control circuit is supplied with the necessary and sufficient feedback signals for a stable operation of a feedback system. Reducing the equivalent series resistance of the capacitor allows suppressing generation of ripple voltage inputted to the battery, making it possible to realize stable charge control.

### BACKGROUND

The present invention relates to a constant voltage and constant current power source for charging a battery provided in a portable electronic device or the like.

The trend in recent years towards lighter and smaller portable electronic devices of ever growing popularity, such as mobile phones, notebook PCs, digital cameras and the like, has widened the scope for the use of rechargeable batteries, capable of repeated charge and discharge, as power sources for such portable electronic devices. Examples of such rechargeable batteries include, for instance, nickel cadmium batteries, nickel hydrogen batteries, lithium ion batteries and the like. To charge such rechargeable batteries are required constant current power sources that stably supply a predetermined DC current to the rechargeable battery.

Japanese Patent Application Laid-open No. 2003-79137 describes a constant current circuit comprising a switching transistor for switching a DC power source, a filter circuit for smoothing the output of the switching transistor, a low-resistance element inserted in series in a current path that supplies output current via the filter circuit, an amplifying circuit for amplifying a voltage drop of the low-resistance element, and a voltage control circuit for comparing an output voltage of the amplifying circuit with a reference voltage and, in accordance with the difference therebetween, controlling the switching duty of a switching pulse wave that is inputted to the gate of the switching transistor.

Among the procedures for charging a rechargeable battery by converting DC voltage outputted by an external DC power supply into a pulse voltage, through the switching operation of a transistor, and by smoothing the pulse voltage using a filter comprising an inductance and a capacitor, there can be used a scheme that involves extracting the ripple voltage generated by the equivalent series resistance (ESR) of a capacitor, and supplying this ripple voltage to a control circuit, as a feedback signal, to realize switching control of a transistor by way of this control circuit.

For performing stably feedback control of a transistor using ripple voltage generated by an equivalent series resistance, it is necessary, however, to use a capacitor having a somewhat high equivalent series resistance, but a high resistance value of the equivalent series resistance of the capacitor results in a larger ripple component of the current supplied to the rechargeable battery, which precludes realizing stable charge control.

### SUMMARY

Thus, an object of the present invention is to provide a constant voltage and constant current power source that enables stable charge control even when using a capacitor having a small equivalent series resistance as a capacitor comprised in a filter for smoothing a pulse voltage generated as a result the switching operation of a switching transistor.

As a means of solving the above problems, the constant voltage and constant current power source for battery charging according to the present invention includes a switching element, a filter, a ripple voltage detection circuit, a first integrating-type error amp, a second integrating-type error amp, and a control circuit. The current input terminal of the switching element, which outputs a pulse voltage by switching DC voltage outputted by an external DC power supply, is connected to the external DC power supply. The filter, for smoothing the pulse voltage, has a capacitor, a resistor element, and an inductance. A first terminal of the capacitor is connected to ground, while a second terminal thereof is connected to a charge terminal of a battery. A first terminal of the resistor element is connected to the second terminal of the capacitor. A first terminal of the inductance is connected to a second terminal of the resistor element, while a second terminal of the inductance is connected to a current output terminal of the switching element. The ripple voltage detection circuit extracts and outputs the ripple voltage generated in the inductance. The first integrating-type error amp outputs a first error signal of the integration over time of the deviation between the DC component of the current flowing through the resistor element and a target value thereof. The second integrating-type error amp outputs a second error signal of the integration over time of the deviation between the DC component of the voltage outputted in the first terminal of the resistor element and a target value thereof. The control circuit performs duty control of the switching operation of the switching element on the basis of the ripple voltage, the first error signal and the second error signal.

In the present invention, the resistor element is functionally homologous to the equivalent series resistance of the capacitor. A capacitor having a low equivalent series resistance can be used as the capacitor by virtue of employing as the resistor element a resistor having a resistance value such that the control circuit is supplied with the necessary and sufficient signals for a stable operation of the feedback system. Reducing the equivalent series resistance of the capacitor allows suppressing generation of ripple voltage inputted to the battery, making it possible to realize stable charge control.

### DESCRIPTION OF DRAWINGS

FIG. 1 is a circuit schematic diagram illustrating a constant voltage and constant current power source according to an embodiment of the invention.

### DETAILED DESCRIPTION

An embodiment of the present invention is explained next with reference to accompanying drawings.

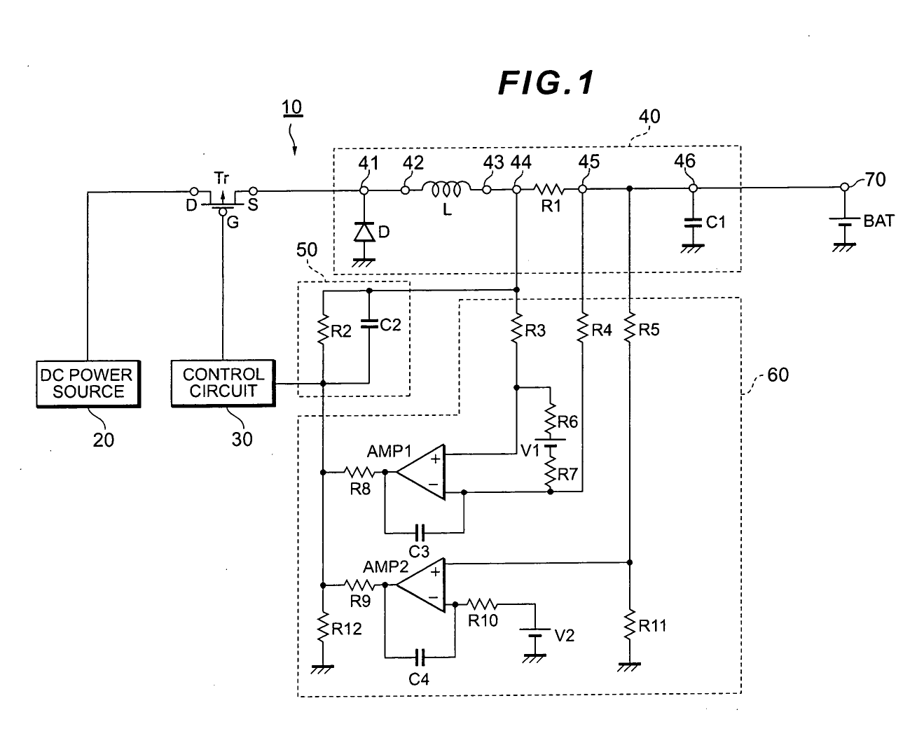

FIG. 1 is a circuit schematic diagram illustrating a constant voltage and constant current power source 10 according to the present embodiment.

The constant voltage and constant current power source 10 is a power source for constant voltage/constant current power charging of a battery BAT (rechargeable battery such as a nickel cadmium battery, a nickel hydrogen battery, a lithium ion battery or the like) incorporated in a portable electronic device (compact disk player, minidisk player or the like), such that DC voltage outputted from a DC power source 20 is converted into pulse voltage through a switching operation of a transistor Tr, this pulse voltage being smoothed into DC voltage by a filter 40, while a feedback signal for constant voltage/constant current power charging is generated by a ripple voltage detection circuit 50 and an error amplifier 60 on the basis of current or voltage generated in a resistor element R1, so that the duty ratio of the switching operation of the transistor Tr is feedback-controlled by a control circuit 30.

The DC power source 20 is, for instance, an external DC power source (about 3V to 10V) derived from a suitable power source (100V AC power source) via an AC adapter (ordinarily comprising a power transformer and a rectifying and smoothing circuit). The DC power source 20 is connected to a current input terminal D of the transistor Tr, such that the DC voltage outputted by the DC power source 20 is converted into a pulse voltage through the switching operation of the transistor Tr.

The filter 40, which is a ripple filter for smoothing the pulse voltage by removing the ripple component in the pulse voltage, has a diode D, an inductance L, the resistor element R1 and a capacitor C1. A first terminal of the capacitor C1 is connected to ground, while a second terminal 46 thereof is connected to a charge terminal 70 of the battery BAT. A first terminal 45 of the resistor element R1 is connected to the second terminal 46 of the capacitor C1. A first terminal 43 of the inductance L is connected to a second terminal 44 of the resistor element R1, while a second terminal 42 of the inductance L is connected to a current output terminal S of the transistor Tr. A first terminal (anode) of the diode D is connected to ground, while a second terminal 41 (cathode) of the diode D is connected to the current output terminal S of the transistor Tr.

When the transistor Tr is on, current flows through the inductance L from the DC power source 20, such that the electric energy of the current is stored in the inductance L as magnetic energy. The current flowing through the inductance L passes through the resistor element R1, is smoothed by the capacitor C1, and is supplied to the battery BAT. On the other hand, when the transistor Tr is switched off, the diode element D becomes switched on, and the energy stored in the inductance L is supplied to the battery BAT via the diode D.

The transistor Tr and the filter 40 function as a step-down DC/DC converter for stepping down the DC voltage outputted by the DC power source 20.

The ripple voltage detection circuit 50, which is branch-connected to a point between the inductance L and the resistor element R1, extracts the ripple voltage flowing through the inductance L, and supplies this ripple voltage to the control circuit 30, as a feedback signal. The ripple voltage detection circuit 50 has a resistor element R2 and a capacitor C2 connected in parallel.

The error amplifier 60 has an integrating-type error amp AMP1 for outputting an error signal of the integration over time of the deviation between the DC component of the current flowing through the resistor element R1 and a target value thereof, and an integrating-type error amp AMP2 for outputting an error signal of the integration over time of the deviation between the DC component of the voltage outputted in the first terminal 45 of the resistor element R1 and a target value thereof.

The integrating-type error amp AMP1 is connected to both terminals of the resistor element R1 via resistor elements R3 and R4, and to the control circuit 30 via a resistor element R8. The error amp AMP1 has a constant voltage source V1 for generating a target voltage (constant current reference voltage) V1 being the product of the resistance value of the resistor element R1 by the target value of the current flowing through the resistor element R1; resistor elements R6 and R7 connected in series to the constant voltage source V1; and a capacitor C3 connected between the output terminal and the non-inverting terminal of the error amp AMP1.

The integrating-type error amp AMP2 is connected to the first terminal 45 of the resistor element R1 via resistor elements R5 and R11, and to the control circuit 30 via resistor elements R9 and R12. The error amp AMP2 has a constant voltage source V2 for generating a target voltage (constant current reference voltage) V2 being equal to the target value of the voltage outputted by the first terminal 45 of the resistor element R1; a resistor element R10 connected in series to the constant voltage source V2; and a capacitor C4 connected between the output terminal and the non-inverting terminal of the error amp AMP2.

The feedback signal outputted by the ripple voltage detection circuit 50 and the feedback signal outputted by the error amplifier 60 are linearly added and supplied to the control circuit 30. On the basis of these feedback signals, the control circuit 30 generates a switching control signal that is inputted to the current control terminal G of the transistor Tr thereby performing duty control (or frequency control) of the switching operation of the transistor Tr. As the control circuit 30 may be used, for instance, a known DC/DC converter controller IC.

The feedback signal outputted by the ripple voltage detection circuit 50 is used for controlling the AC component of the current/voltage supplied to the battery BAT, while the feedback signal outputted by the error amplifier 60 is used for controlling the DC component (offset value) of the current/voltage supplied to the battery BAT.

In the present embodiment, the resistor element R1 is a functional equivalent of the ESR (equivalent series resistance) of the capacitor C1. A capacitor having a low equivalent series resistance (for instance, a ceramic capacitor or the like) can be used as the capacitor C1 by virtue of employing as the resistor element R1 a resistor having a resistance value such that the control circuit 30 is supplied with the necessary and sufficient signals for a stable operation of the feedback system. Reducing the equivalent series resistance of the capacitor C1 allows suppressing generation of ripple voltage inputted to the battery BAT, making it possible to realize stable charge control, and contributing also to shrink the size of the constant voltage and constant current power source 10.

In the present embodiment, the error amps AMP1 and AMP2 for supplying to the control circuit 30 an error signal of the integration over time of the deviation between a control object that can be converted into voltage and a target voltage (reference voltage), as a feedback signal, allow controlling arbitrary physical magnitudes (for instance, temperature or the like) that can be converted into voltage, expanding thus the range of possible applications of the constant voltage and constant current power source 10.

We claim:

1. A constant voltage and constant current power source for charging a battery, comprising:
a switching element for outputting a pulse voltage by switching DC voltage outputted by an external DC power supply;
a filter for smoothing the pulse voltage, having a capacitor with a first terminal thereof connected to ground and a second terminal connected to a charge terminal of the battery, a resistor element with a first terminal thereof connected to the second terminal of the capacitor, and an inductance with a first terminal thereof connected to a second terminal of the resistor element and a second terminal connected to a current output terminal of the switching element;
a ripple voltage detection circuit for extracting ripple voltage generated in the inductance, and for outputting the ripple voltage;
a first integrating-type error amp for outputting a first error signal of integration over time of a deviation between a DC component of current flowing through the resistor element and a target value thereof;
a second integrating-type error amp for outputting a second error signal of integration over time of a deviation between the DC component of voltage outputted by the first terminal of the resistor element and a target value thereof;
and a control circuit for carrying out duty control of a switching operation of the switching element on the basis of the ripple voltage, the first error signal and the second error signal.
